(19) United States
(12) Patent Application Publication
(10) Pub. No.: US 2025/0381798 A1
(43) Pub. Date: Dec. 18, 2025

(54) DIRECTIONAL LOCKING PLATE

(71) Applicant: Jesse James HAHN, Cedar Rapids, IA (US)

(72) Inventor: Jesse James HAHN, Cedar Rapids, IA (US)

(21) Appl. No.: 19/236,166

(22) Filed: Jun. 12, 2025

Related U.S. Application Data
(60) Provisional application No. 63/659,145, filed on Jun. 12, 2024.

(51) Int. Cl. B60B 33/02

(52) U.S. Cl. CPC B60B 33/02

(57) ABSTRACT

A directional locking plate for a caster wheel assembly to directionally lock the movement of the caster wheel by fitting on the frame of the assembly. A directional locking plate with a hollow base portion and a tab with sidewalls which lock the frame of the caster wheel assembly. A directional locking plate with one or more cutouts along at least one of the outside and the inside of the plate, in which a lock pin fits to directionally lock the caster wheel assembly. A directional locking plate with a hollow base portion and a tab, wherein the base includes a projection towards the tab which fits on the top of the frame of the caster wheel assembly and the tab includes a projection which fits under the frame of the caster wheel assembly. A directional locking plate including a lock pin and pin plate within which the lock pin fits.

This application claims priority to U.S. Provisional Patent Application No. 63/659,145 filed Jun. 12, 2024, the entirety of which is incorporated by reference herein.

### BACKGROUND OF THE INVENTION

Casters are commonly attached to surfaces to allow for rolling movements of carts, trailers, trucks, dollies, and other such transport vehicles. Casters typically include a caster stem or plate attached to a frame, which is connect to a wheel at its axis of rotation.

Casters may rotate around a vertical axis at the caster stem or plate, or casters may be fixed at one position relative to the vertical axis at the caster stem or plate. Swiveling casters include a frame that is rotatably coupled with the caster stem or plate such that the frame and wheels swivel about the vertical axis of the caster stem or plate, relative to the caster stem or plate, allowing for multi-directional movement. Multi-directional movement can aid in turning or steering.

Swivel casters are helpful for such maneuverability, but can be difficult to keep in line in one direction on a transport vehicle. Transport vehicles may have swivel casters on the operator-end of the transport vehicle, which is the vehicle end on which an operator pushes or pulls to move the vehicle. This operator-end may feature a handle upon which the operator may push or pull to move the transport vehicle. In some instances, a transport vehicle may feature swivel casters provided on the operator-end of the vehicle having the handle, and rigid casters provided on the vehicle end opposite the operator-end. However, for maximum maneuverability, a vehicle may have only swivel casters. For example, a furniture dolly has only swivel casters, making it easy to maneuver in small spaces. However, consistent directional control upon a straight path is difficult with this arrangement. To provide both tight space maneuverability and easy directional control along longer paths, swivel casters may include swivel locks, which lock the swivel caster into place and allow it to function as a rigid caster while locked.

Typically such swivel locking casters are built with locks, and it can be difficult to retro-fit a swivel caster to directionally lock. Methods of locking a swivel caster typically include disassembling the caster and adding a locking mechanism to the frame or removing material from the frame of the caster to add a locking feature. However, both of these strategies take time and can impair the integrity of the caster wheel.

Accordingly, there is a need for a caster wheel directional locking system that addresses the challenges and drawbacks associated with swivel casters as presented above.

### SUMMARY OF THE INVENTION

The directional locking plate adds a directional lock control to a standard caster frame. The DLP may be made of any type of metal or plastic, and can attach to an existing swivel caster frame.

### BRIEF DESCRIPTION OF THE DRAWINGS

FIG. 1 is a top view of the directional locking plate.

FIG. 2 is an isometric view of the directional locking plate.

FIG. 3 is a front view of the directional locking plate.

FIG. 4 is a side view of the directional locking plate.

FIG. 5 shows a lock pin and standard nut

FIG. 6 shows a pin plate with pin sleeve.

FIG. 7 shows a standard caster frame.

FIG. 8 shows a caster frame with directional locking plate.

FIG. 9 shows a caster frame with the directional locking plate and pin plate.

FIG. 10 shows the pin in locked position.

FIG. 11 shows the pin in unlocked position.

FIG. 12 shows the pin resting on the directional locking plate.

FIG. 13 shows the pin resting on the directional locking plate.

FIG. 14 shows the pin with a frame structure.

### DETAILED DESCRIPTION OF THE INVENTION

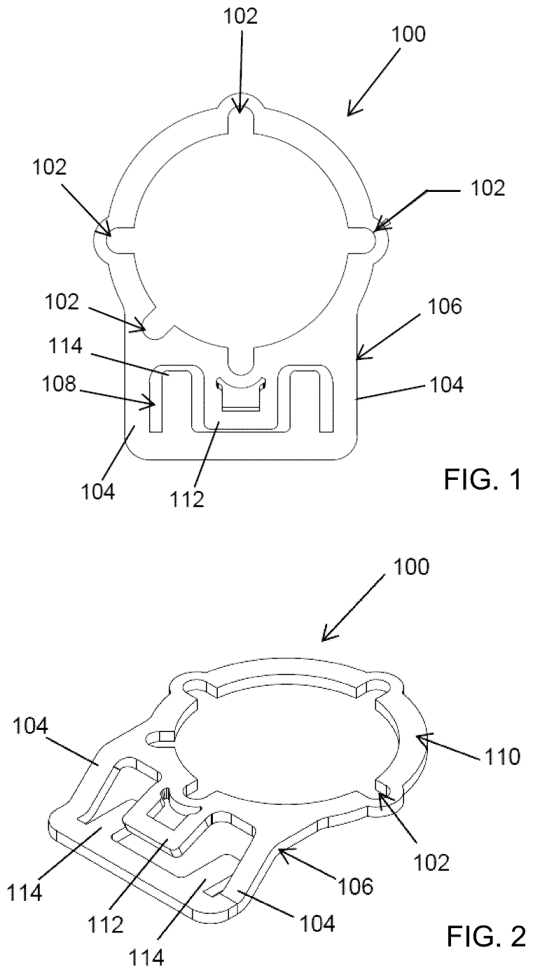

A standard caster (130) shown in FIG. 7 is free to swivel by design. FIGS. 1-4 illustrate the features and shape of one example of the directional locking plate (100). The directional locking plate (100) adds a directional lock control to a standard caster frame (130). Adding the directional locking plate (100) enables locking of the swivel motion of a standard caster.

FIG. 1 shows a top view of the directional locking plate (100). The top surface of the directional locking plate (100) may be disc-shaped. The directional locking plate (100) may be concentric to the swivel axis of the caster (130). The directional locking plate (100) includes a base plate (110) portion which has a hollow center. The base plate (110) may include one or more base plate cutouts (102) located around the inside of the hollow center or the outside perimeter of the base plate (110).

The directional locking plate (100) may include at least one tab (106) extending from a side of the base plate (110). The at least one tab (106) may include tab sidewalls (104) at either side of the tab (106) adjacent to one or more tab cutouts (108). In one embodiment, the tab (106) includes a tab cutout (108) and tab sidewalls (104) on either side of the tab cutout (108). The tab (106) may extend downward from the base plate (110).

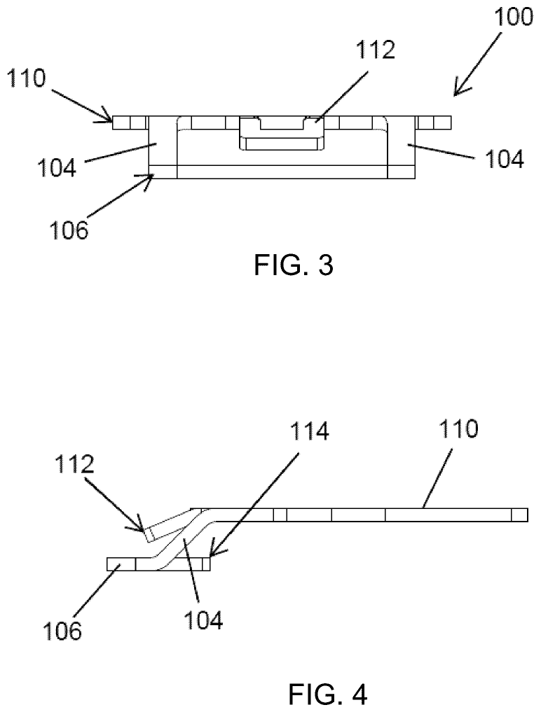

FIG. 3 shows a front view of the directional locking plate (100). The at least one tab (106) may be substantially parallel, but on a different plane than the base (110) of the directional locking plate (100).

FIG. 4 shows a side view of the directional locking plate (100). The base plate (110) may include at least one base extension (112) extending from the base plate (110) toward the tab (106). The base extension (112) may project from the base and into the tab cutout (108). The tab (106) may include at least one tab extension (114) extending from the tab (106) toward the base plate (110). The tab (106) may include two tab extensions (114) projecting from the tab (106) toward the base plate (110) wherein the base extension (112) is located between the two tab extensions (114).

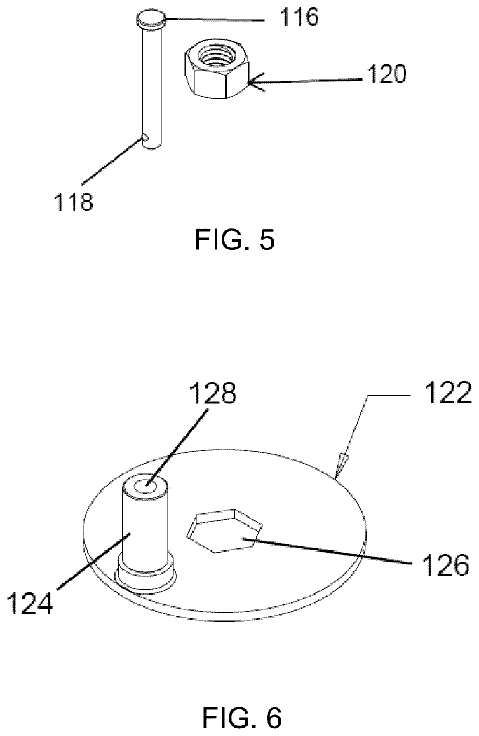

FIG. 5 shows a lock pin (116) and nut (120) which may be used to directionally lock the caster wheel assembly (130). The lock pin (116) may include a detent (118) to secure the lock pin (116) in place.

FIG. 6 shows a pin plate (122) which may be assembled with the directional locking plate (100) to directionally lock the caster wheel assembly (130). The pin plate (112) may include a pin sleeve ((124) and pin sleeve channel (128). The pin plate (112) may also include a void (126) in a location on the pin plate (122). The void (126) may be located in substantially the center of the pin plate (122).

FIG. 7 shows a caster wheel assembly (130) with a caster frame (132).

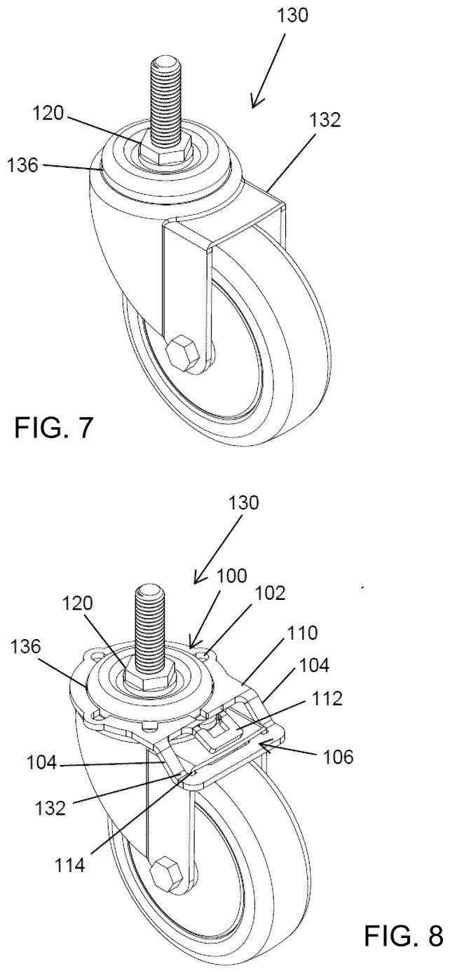

FIG. 8 shows the directional locking plate (100) positioned around the top bearing race (136) of the caster wheel assembly (130), and rests on the caster frame (132). Tab extensions (114) are inserted under the caster frame (132). The base extension (112) is over the caster frame (132) and the caster frame (132) edges are located between the tab sidewalls (104).

The lower level forward facing tab extensions (114) limit upward motion of the directional locking plate (100). Tab extensions (114) and the base extension (112) act together to limit rotation of the directional locking plate (100). The combined tab extensions (114) and the base extension (112) restrict horizontal, vertical and rotational movement of the directional locking plate (100) relative to the swivel portion of the caster assembly (130). Rotation of the caster frame (132) is resisted by the inside edges of the tab sidewalls (104) in contact with the outer side surfaces of the caster frame (132).

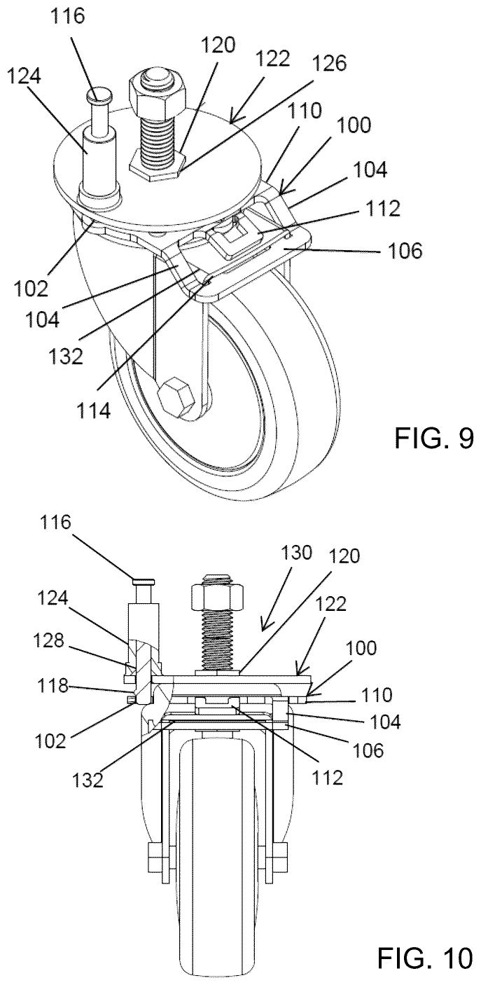

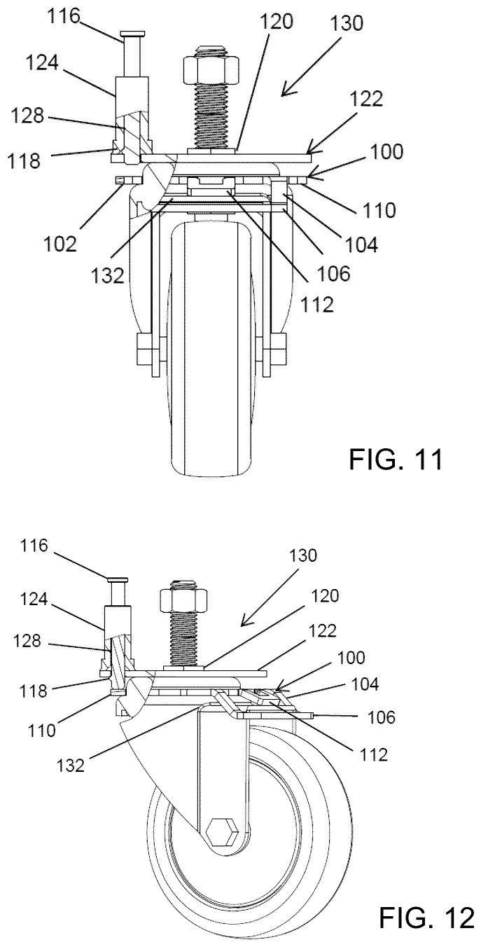

FIG. 9 shows the pin plate (122) applied to the caster assembly (130) on top of the directional locking plate (100).

In locked position, an embodiment of which is shown in FIG. 10, the lock pin (116) is inserted into a base plate cutout (102). If the base plate cutout (102) is located on an inside edge of the base plate (110) by the hollow center, the lock pin (116) is inserted vertically. If the base plate cutout (102) is located on an outside edge of the base pate (110), the lock pin (116) may be inserted vertically or horizontally into the base plate cutout (102). A horizontal pin might be required in cases where there is not clearance for lock pin (116) location vertically.

The lock pin (116) may be square in profile. The square profile would be preferred when a horizontal lock pin (116) engagement is chosen. This may make alignment easier and allow use of a thinner directional locking pate (100) without reducing locking capability.

Another method of locking could be by use of a pivoting pawl that can be rotated into base plate cutout (102) on the directional locking plate (100).

Another method of locking could be the use of a disc brake caliper that would grip the directional locking plate (100) as used on vehicles or machines using disc brakes to slow or stop motion. In this case the directional locking plate (100) may not have base plate cutout (102), but instead include a larger diameter disc that extends outward from the caster frame (132) such that the brake caliper can grip the disc at any angle of rotation.

The lock pin (116) may be restrained the pin plate (122). The pin plate (122) may be added and restrained by its matching pin plate void (126) that fits over a component on the caster assembly (130). In one embodiment, the pin plate void (126) is hexagonal shaped and fits over a hex bolt in the caster assembly (130), which prevents the rotation of the pin plate (122) when the caster assembly (130) is mounted to the frame of a structure. In another design, the lock pin (116) could be passed through a frame component (134) of a structure or vehicle, of which the standard caster assembly (130) may be assembled to as shown in FIG. 14.

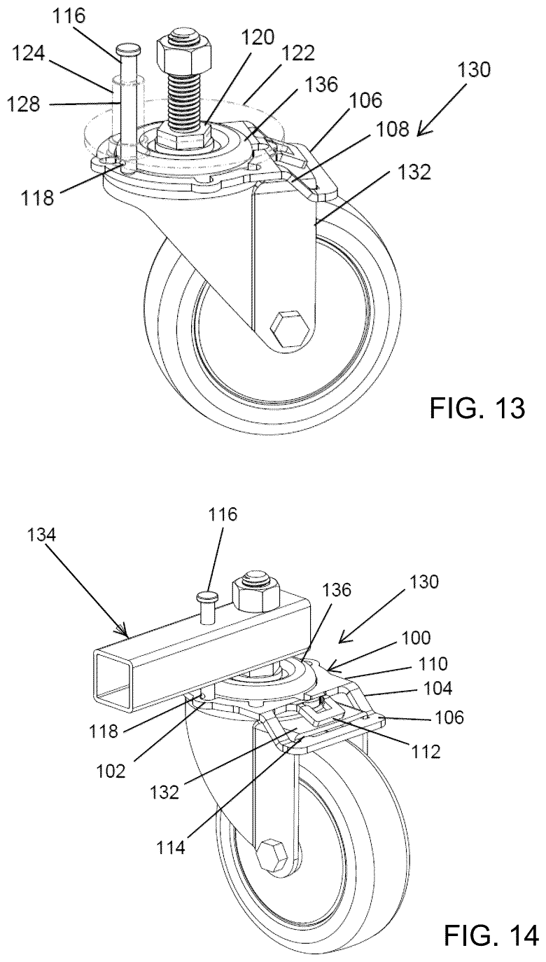

If the lock pin (116) is moved from “unlock” position towards locked position at any time that the swiveled caster assembly (130) is at a rotation angle such that when the lock pin (116) is not aligned to one of the base plate cutouts (102), the lock pin (116) will rest on the top surface of the directional locking plate (100) as shown in FIG. 12 and FIG. 13. The lock pin (116) will drop into a base plate cutout (102) after the caster assembly (130) is rotated enough to align a base plate cutout (102) to the lock pin (116) location.

The lock pin (116) could be spring loaded to insure that is engages in case there may be some friction resisting its fall, or if the lock pin (116) is to be used horizontally.

What is claimed is:

1. A directional locking plate, comprising:
a base plate with a hollow center; and
a tab extending from the base plate, wherein the tab includes a tab cutout and tab sidewalls on either side of the tab cutout.

2. The directional locking plate of claim 1, wherein the tab extends downward at an angle from the base plate.

3. The directional locking plate of claim 1, further comprising at least one base extension projecting from the base plate toward the tab.

4. The directional locking plate of claim 3, wherein the at least one base extension projects into the tab cutout between the tab sidewalls.

5. The directional locking plate of claim 1, further comprising at least one tab extension projecting from the tab toward the base plate.

6. The directional locking plate of claim 3, further comprising two tab extensions projecting from the tab toward the base plate, and wherein the base extension is located between the two tab extensions in an overhead view of the directional locking plate.

7. The directional locking plate of claim 1, wherein the base plate includes at least one base plate cutout located in at least one chosen from an inside edge of the base plate adjacent to the hollow center and an outside edge of the base plate.

8. The directional locking plate of claim 7, further comprising a lock pin, wherein the lock pin is set in the at least one base plate cutout to prevent rotation of the base plate.

9. The directional locking plate of claim 8, wherein the at least one base plate cutout is located in an inside edge of the base plate adjacent to the hollow center, and wherein the lock pin inserts vertically into the at least one base plate cutout.

10. The directional locking plate of claim 8, wherein the at least one base plate cutout is located on the outside edge of the base plate, and wherein the lock pin inserts vertically or horizontally into the at least one base plate cutout.

11. The directional locking plate of claim 8, wherein the lock pin includes a detent assembly which prevents vertical movement of the lock pin in the at least one base plate cutout.

12. The directional locking plate of claim 8, further comprising a pin plate applied to the base plate, wherein the pin plate includes a pin sleeve with a pin sleeve channel for receiving the lock pin.

13. The directional locking plate of claim 8, further comprising a vehicle frame, wherein the lock pin is positioned through the vehicle frame.

14. The directional locking plate of claim 3, further comprising:
a caster assembly with a caster frame;
at least one tab extension projecting from the tab toward the base plate; and
wherein the base plate is applied to the caster assembly, and wherein a portion of the caster frame fits between the tab sidewalls and the portion of the caster frame is between the tab extension and the base extension.

15. A locking caster assembly comprising:
a caster wheel;
a caster frame attached to the caster wheel;
a central screw attached to the caster frame, wherein the caster frame includes;
a bearing race allowing the caster wheel and the caster frame to swivel a 360° rotation with respect to an axis parallel to the central screw;
a directional locking plate with a hollow center applied to the central screw and fitting one chosen from on top of or around the bearing race, wherein the directional locking plate attaches to the caster frame and rotates together with the caster wheel and the caster frame;
wherein the directional locking plate includes an outside edge, an inside edge adjacent to the hollow center, and a cutout located in at least one chosen from the outside edge or the inside edge; and
a lock pin fitted into the cutout which locks a rotation of the directional locking plate, the caster frame and the caster wheel.

16. The locking caster assembly of claim 15, further comprising:
a pin plate including a
a central screw;
a bearing race located around the a central screw; and
a nut located at a base of the central screw;
wherein the bearing race fits into the hollow center of the directional locking plate;
wherein the pin plate includes a void substantially the same shape as the nut;
wherein the nut fits into the void of the pin plate; and
where the nut prevents rotation of the pin plate around the central screw.
